(19) United States
(12) Patent Application Publication
(10) Pub. No.: US 2006/0179713 A1
(43) Pub. Date: Aug. 17, 2006

(54) Planter cover

(76) Inventor: Virginia Rose Smith Roberts, Huntington, IN (US)

Correspondence Address: TAYLOR & AUST, P.C., 142 SOUTH MAIN STREET, P. O. BOX 560, AVILLA, IN, 46710, US

(21) Appl. No.: 11/348,917

(22) Filed: Feb. 7, 2006

Related U.S. Application Data
(60) Provisional application No. 60/653,055, filed on Feb. 15, 2005.

(51) Int. Cl. A01G 9/02

(52) U.S. Cl. 47/72

(57) ABSTRACT

A plant container covering system including a planter and a cover. The planter having an outer surface. The cover being held against the outer surface. The cover including a first side, a second side, a first end, a second end and connection features. The second side is opposite the first side. The first end being adjacent to the first side and the second side. The second end being opposite the first end. The connection features connect the first end and the second end to each other.

### CROSS REFERENCE TO RELATED APPLICATIONS

This is a non-provisional application based upon U.S. provisional patent application Ser. No. 60/653,055, entitled “Planter Cover”, filed Feb. 15, 2005.

### BACKGROUND OF THE INVENTION

1. Field of the Invention

The present invention relates to a cover for a planter, and, more particularly, to a reversible cover for a planter.

2. Description of the Related Art

From time in immemorial, containers have been utilized to place dirt and various organic items for the nourishment of plants, in a container and placing plants in various arrangements therein. The horticultural aspect of using plant containers are for the production of edible fruits and vegetables as well as for decorative purposes. Plant containers such as pots are often decorated by way of painting, glazing, carving and three dimensional reliefs placed thereon. Plant containers can take various shapes including conical sections, semi-circular shapes, rectilinear and essentially any shape that can contain the requisite support and nourishment items for a plant.

Unadorned pots are often wrapped with a formable paper or foil to lend some decor to an otherwise plain container. Disadvantageously, such coverings are wrapped from the bottom causing limited access to any drain trays or drainage release built into the plant container.

What is needed in the art is a versatile, economic cover for planter containers.

### SUMMARY OF THE INVENTION

The present invention relates to a reversible, connectable planter cover for application to an outside surface of a plant container.

The invention comprises in one form thereof, a plant container covering system including a planter having an outer surface and a cover held against the outer surface. The cover includes a first side, and second side, a first end and a second end. The second side is opposite the first side and the first end is adjacent the first side and the second side. The second end is opposite the first end and the first end is connectable to the second end.

Advantageously the present invention is held to a planter pot by tension contained in the cover.

Another advantage of the present invention is that the cover is reversible having different designs on each side thereof.

Another advantage of the present invention is that the cover does not extend down into a drainage tray.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective exploded view of an embodiment of plant container covering system of the present invention;

FIG. 2 is a perspective view of the cover of FIG. 1;

FIG. 3 is a perspective view of another embodiment of a plant container covering system of the present invention;

FIG. 4 is a perspective view of yet another embodiment of a plant covering system of the present invention;

FIG. 5 is a perspective view of the cover of FIGS. 1 and 2;

FIG. 6 is a partially sectioned view of another embodiment of a planter cover of the present invention;

FIG. 7 is a planar view of the cover of FIGS. 1 and 2; and

FIG. 8 is a perspective view of another embodiment of the planter cover of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

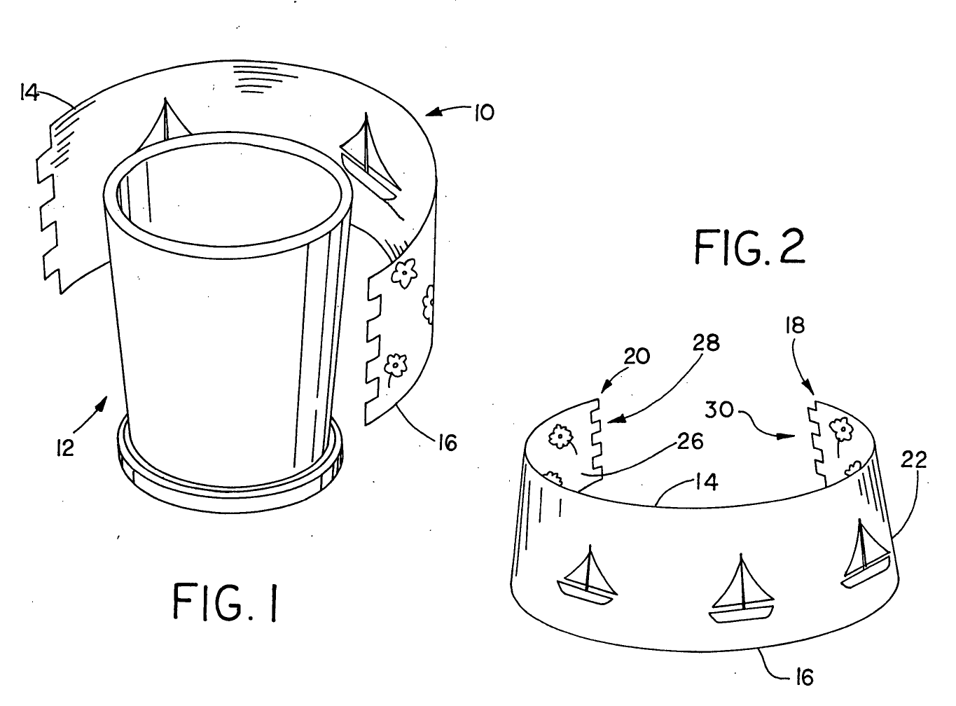

Referring now to the drawings, and more particularly to FIGS. 1 and 2, there is illustrated planter cover 10 that is placed around a planter pot 12. Cover 10 includes a top edge 14, a bottom edge 16, fasteners 18, receptors 20, a first surface 22, a second surface 26, and ends 28 and 30. Planter pot 12 is conventional pot, which may be made from a clay material and fired having a quasi-conical sectional shape. Top edge 14 may be located proximate to a top edge of pot 12 and is pulled around pot 12 to bring fasteners 18 and receptors 20 together so as to fasten cover 10 to pot 12. Bottom edge 16 is generally above the drainage tray of pot 12. Cover 10 is held against pot 12 by way of tension due to the stretchable nature of cover 10, as cover 10 is placed around pot 12. Fasteners 18 and receptors 20 may be adjustable so as to provide for an adjustable tension situation dependent upon the shape of pot 12. Ends 28 and 30 are brought together, or are overlapped as cover 10 is joined about pot 12. First surface 22 and second surface 26 may have different illustrations thereon, which advantageously allows for a dual use of planter cover 10. Planter pot 12 may be decorated for occasions by having multiple planter pot covers 10 so as to provide for two occasions or decorative themes with each cover 10. For example, one side 22 may display a spring theme and the opposite side 26, may sport a birthday greeting.

Ends 28 and 30 have connection features attached to each of them. The connection features are shown in FIGS. 1 and 2 as an interleaved structure. The interleaved structure on end 28 is complimentary to the structure on end 30. The interleaved structure can be as depicted with tabs of one end filling slots on the other end, or can have various shapes. The tabs may have adhesive portions that adhere to a surface of cover 10 as the tabs extend through the complimentary slots. The adhesive may be of an easily removable type, thereby allowing the easy removal and reuse of cover 10 in a nondestructive manner.

Now, additionally referring to FIG. 3 there is shown a box like shaped pot 12 with cover 10 therearound. A fastener strip 24 is placed over cover 10 where ends 28 and 30 join to thereby fasten cover 10 to pot 12.

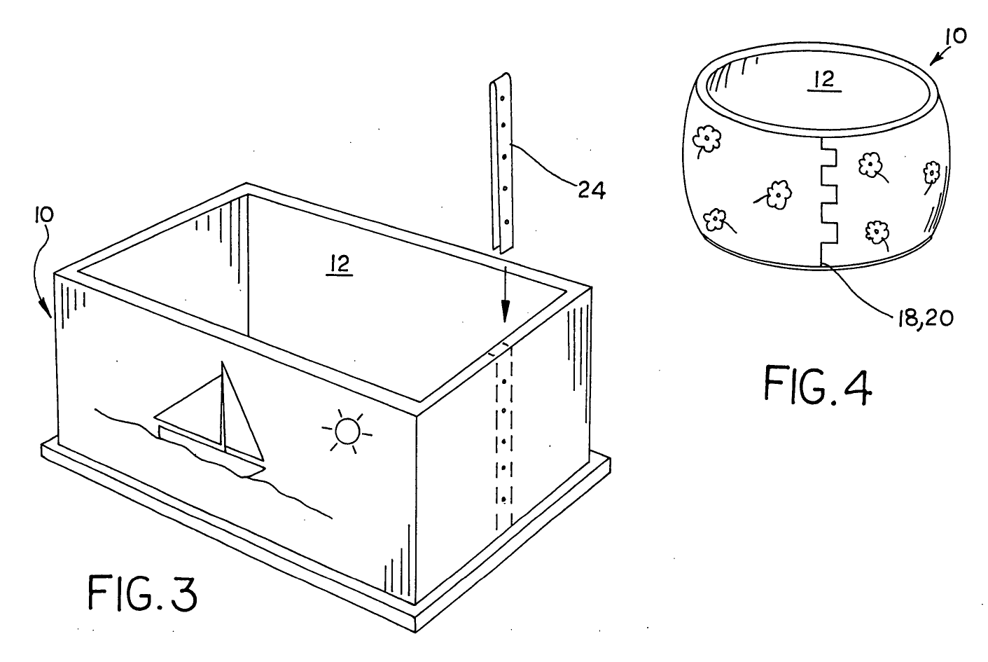

Now, additionally referring to FIG. 4 there are shown a pot 12 having a quasi-spherical shape with planter cover 10 having a resilient nature and stretching to accommodate the shape of the shape of pot 12.

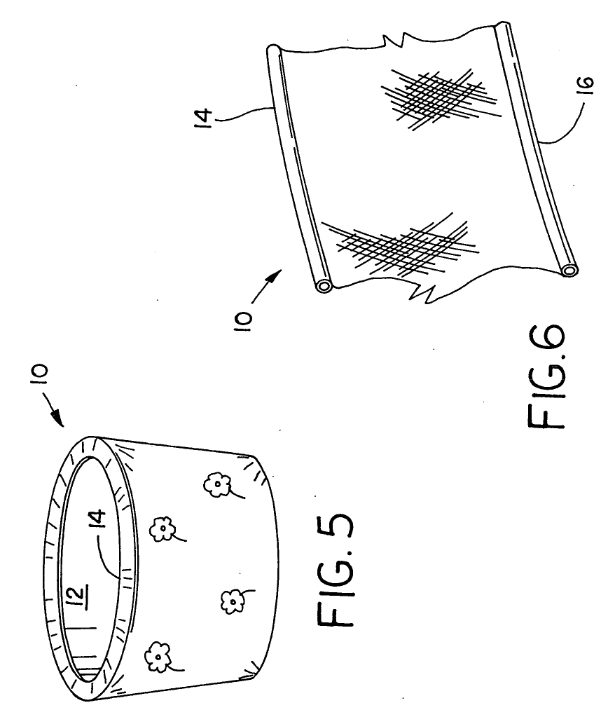

Now, additionally referring to FIG. 5, there is shown a planter cover 10 with top edge 14 drawn over a top edge of pot 12 with top edge 14 having an elastic nature, as also illustrated in FIG. 6, with top edge 14 and bottom edge 16 being made of a resilient elastic type material, which provides for an additional tension member.

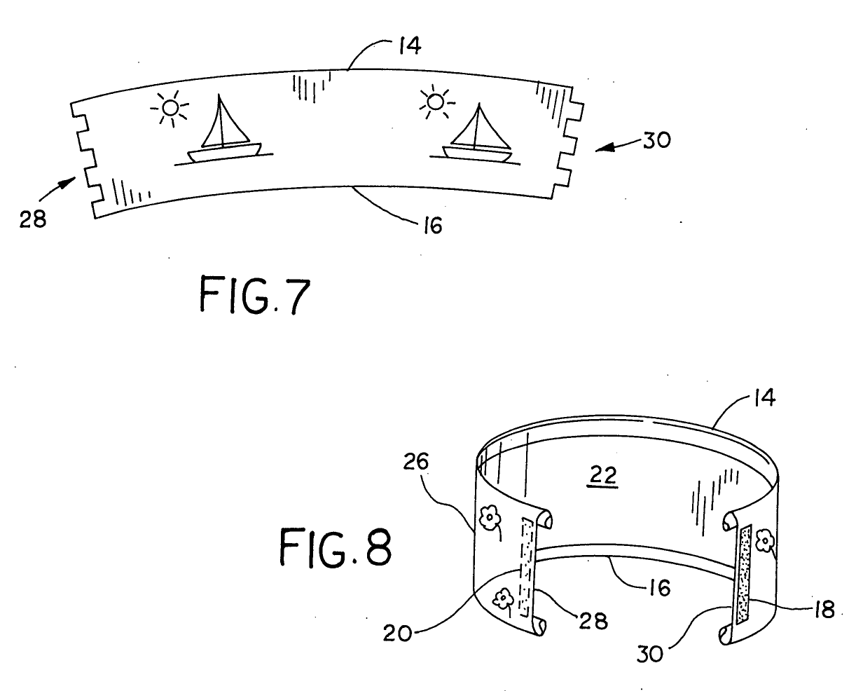

Now, additionally referring to FIG. 7, there is shown a planar view of cover 10 having a top edge 14 that is longer than bottom edge 16. Also top edge 14 and bottom edge 16 may have a curved or otherwise shaped edge as viewed in a planar view. This advantageously allows for the accommodation of a larger circumferential top of pot 12 with a smaller circumferential distance for a lower portion of pot 12.

Now, additionally referring to FIG. 8, there is shown another embodiment of planter cover 10 having top edge 14 rolled over and bottom edge 16 rolled over to accommodate a different height of pot 12. Fasteners 18 and receptors 20 may be in the form of attached hook and loop type connectors, which can be variously placed along a length of cover 10.

Installation of planter cover 10 around pot 12 includes the vertical positioning of top edge 14 proximate to a top edge of pot 12 or with top edge 14 being placed slightly above the top edge of pot 12 to thereby allow top edge 14 to draw over the top edge of pot 12. Bottom edge 16 may be installed at its full unfurled height or rolled up to shorten cover 10 during installation. Tension is placed on cover 10 as it is wrapped around pot 12 and fasteners 18, also known as connectors 18, are connected to receptors 20. Alternatively, a fastener 24, separate from fasteners 18 and receptors 20, may be applied over a seam of planter cover 10. Although not shown, more then one planter cover 10 may be joined to accommodate large outer perimeter plant containers, perhaps as shown in FIG. 3.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A plant container covering system, comprising:
a planter having an outer surface;
a cover held against said outer surface, said cover including:
a first side
a second side being opposite said first side;
a first end adjacent said first side and said second side;
a second end opposite said first end; and
connection features that connect said first end and said second end to each other.

2. The system of claim 1, wherein said cover is held against said outer surface by tension of said cover.

3. The system of claim 1, wherein said connection features include a separate fastener connecting said first end to said second end.

4. The system of claim 1, wherein said connection features include connectors and receptors, said connectors being attached to said first end, said receptors being attached to said second end, said receptors interacting with said connectors to detachably connect said first end to said second end.

5. The system of claim 1, wherein said cover further comprises:
a first edge extending from said first end to said second end; and
a second edge extending from said first to said second end, at least one of said first edge and said second edge being stretchable.

6. The system of claim 5, wherein both said first edge and said second edge are stretchable.

7. The system of claim 1, wherein said first side and said second side are interchangeable relative to said planter.

8. The system of claim 5, wherein said first edge extends over a top portion of said planter.

9. The system of claim 1, wherein said connection features include complimentary interleaved structures on said first end and said second end.

10. A plant container cover positioned against an outer surface of a plant container, the cover comprising:
a first side
a second side being opposite said first side;
a first end adjacent said first side and said second side;
a second end opposite said first end; and
connection features that connect said first end and said second end to each other.

11. The cover of claim 10, wherein the cover is held against said outer surface by tension of the cover.

12. The cover of claim 10, wherein said connection features include a separate fastener connecting said first end to said second end.

13. The cover of claim 10, wherein said connection features include connectors and receptors, said connectors being attached to said first end, said receptors being attached to said second end, said receptors interacting with said connectors to detachably connect said first end to said second end.

14. The cover of claim 10, further comprising:
a first edge extending from said first end to said second end; and
a second edge extending from said first to said second end, at least one of said first edge and said second edge being stretchable.

15. The cover of claim 14, wherein both said first edge and said second edge are stretchable.

16. The cover of claim 10, wherein said first side and said second side are interchangeable relative to the plant container.

17. The cover of claim 14, wherein said first edge extends over a top portion of the plant container.

18. The cover of claim 10, wherein said connection features include complimentary interleaved structures on said first end and said second end.

19. A method of covering a plant container, comprising the steps of:
tensioning a cover about a surface of the plant container;
interleaving ends of said cover; and
connecting said ends.

20. The method of claim 19, wherein said connecting step is accomplished in a nondestructive removable manner.
